(19) United States
(12) Patent Application Publication
(10) Pub. No.: US 2006/0055519 A1
(43) Pub. Date: Mar. 16, 2006

(54) Tire pressure monitoring system and method

(76) Inventor: Seon Gyu Jeon, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/226,708

(22) Filed: Sep. 13, 2005

(30) Foreign Application Priority Data
Sep. 13, 2004 (KR) 10-2004-0073042

(51) Int. Cl. B60R 25/10

(52) U.S. Cl. 340/426.33

(57) ABSTRACT

A tire pressure monitoring system includes a plurality of TPMS sensors for measuring air pressure of respective tires and outputting electronic wave signals corresponding to the pressures, a plurality of exciters for outputting electronic wave signals for activating the respective TPMS sensors, a plurality of antennas provided in correspondence to the respective TPMS sensors and receiving electronic wave signals from the TPMS sensors, and a control portion connected to the antennas and calculating signals received by the antennas, wherein the control portion compares intensities of the plurality of electronic wave signals being received by the plurality of antennas, and selects an electronic wave signal from a particular TPMS sensor from among the plurality of electronic wave signals being received by a particular antenna, based on the comparison.

### CROSS-REFERENCE TO RELATED APPLICATION

This application claims priority to and the benefit of Korean Patent Application No. 10-2004-0073042 filed in the Korean Intellectual Property Office on Sep. 13, 2004, the entire contents of which are incorporated herein by reference.

### BACKGROUND OF THE INVENTION

(a) Field of the Invention

The present invention relates to a tire pressure monitoring system and method. More particularly, the present invention relates to a tire pressure monitoring system and method that are capable of preventing cross-talk.

(b) Description of the Related Art

A tire pressure monitoring system, called TPMS, is used for indicating information about tire pressure and sending an alarm when there is a danger. Typically, the TPMS includes four TPMS sensors having their own IDs, installed at or near the respective four tires. Therefore, when the TPMS sensors measure tire pressure, the measured information is transferred to an ECU and is displayed on a display, such that a driver can notice a problem with the tires.

Here, some problems occur because of a characteristic of the wireless communication between devices in the TPMS, including the TPMS sensors. For example, an exciter, as a kind of wireless installation, outputs a 125 KHz LF signal to the TPMS sensor having an ID corresponding to the exciter, such that the TPMS sensor responds and outputs an electronic wave signal including information measured by the TPMS sensor. However, other TPMS sensors can respond to the output electronic wave signal of the exciter, and information about another tire (detected by another TPMS sensor having a different ID) can be transferred.

Installation of the TPMS in vehicles is mandated by the NHTSA (National Highway Traffic Safety Administration) rule FMVSS138, and some countries force installation of a TPMS in vehicles. If a tire pressure is reduced by 25% and the vehicle runs at a high speed, the tire is irregularly worn which may cause a blowout, which is why the installation of the TPMS is forced.

Components for constructing the TPMS are divided into two groups. The first group consists of devices installed in a vehicle, and the second group consists of devices installed outside the vehicle for operating the devices installed in the vehicle. A main cause of problems in wireless communications is a cross-talk phenomenon wherein there is mis-recognition of a wireless component ID.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a tire pressure monitoring system having advantages of preventing a cross-talk phenomenon, decreasing an error rate due to the wireless communication, and reducing the total cost of repair and maintenance.

An exemplary tire pressure monitoring system according to an embodiment of the present invention includes a plurality of TPMS sensors measuring air pressure of respective tires and outputting electronic wave signals corresponding to the pressures; a plurality of exciters for outputting electronic wave signals for activating the respective TPMS sensors; a plurality of antennas provided in correspondence to the respective TPMS sensors and receiving electronic wave signals from the TPMS sensors; and a control portion connected to the antennas and calculating signals received by the antennas, wherein the control portion compares an intensity of the plurality of electronic wave signals being received by the plurality of antennas, and selects an electronic wave signal from a particular TPMS sensor among a plurality of electronic wave signals being received by a particular antenna, based on the comparison.

The control portion may determine whether a frequency of the electronic wave signal outputted from the TPMS sensor is included in a predetermined frequency range.

The output signal of the exciter may be an LF signal having a frequency of 125 KHz. The output signal of the TPMS sensor may be an RF signal having a frequency of 315 MHz. The antenna may be a directional UHF antenna, and the control portion may be installed in the antenna.

The control portion includes an OP-AMP comparator for comparing a frequency of the electronic wave signal inputted through the antenna.

An exemplary method for monitoring tire pressure according to an embodiment of the present invention includes receiving an electronic wave signal, determining whether the electronic wave signal is outputted from a TPMS sensor by comparing the frequency of the electronic wave signal with a predetermined frequency range, comparing an intensity of the electronic wave signal being received by the antennas, and selecting a particular electronic wave signal among the electronic wave signals being received by the antennas, based on the comparison.

### BRIEF DESCRIPTION OF THE DRAWINGS

FIG. 1 and FIG. 2 show schematic structures of a typical tire pressure monitoring system.

FIG. 3A to FIG. 3E show operations of a tire pressure monitoring system.

FIG. 4 is a table showing examples of ID mapping.

FIG. 5 shows an example of a display of a tire pressure monitoring system.

FIG. 6 is a schematic drawing of a tire pressure monitoring system (TPMS) according to an exemplary preferred embodiment of the present invention.

FIG. 7 is a schematic block diagram showing a receiving method of an antenna according to an exemplary preferred embodiment of the present invention.

FIG. 8 is a schematic circuit diagram of a frequency comparator according to an exemplary embodiment of the present invention.

### DETAILED DESCRIPTION OF THE EMBODIMENTS

An exemplary embodiments of the present invention will hereinafter be described in detail with reference to the accompanying drawings.

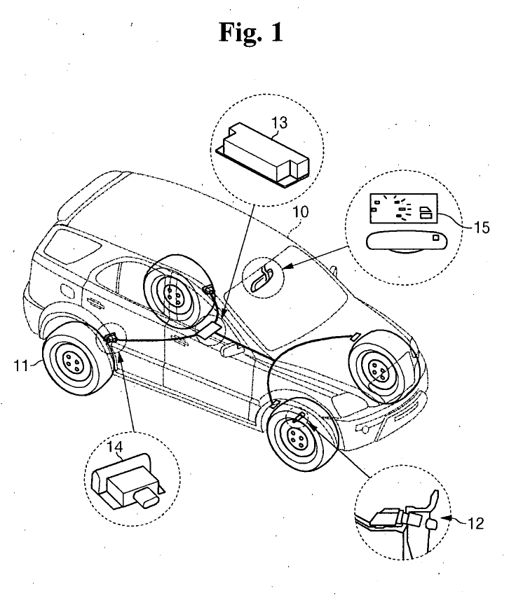

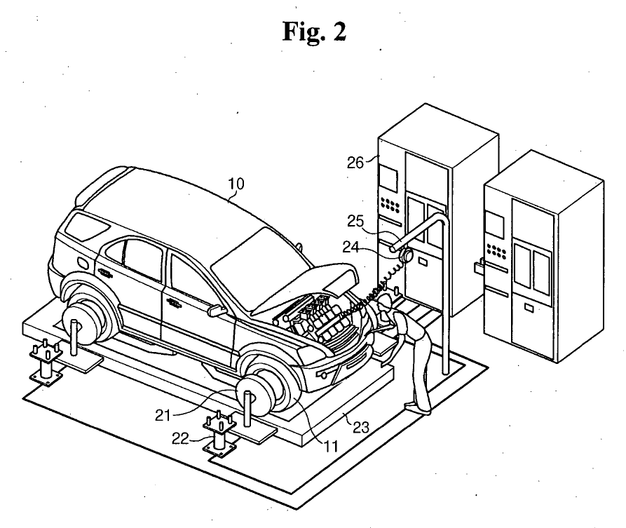

As shown in FIG. 1, a TPMS for a vehicle 110 includes a TPMS sensor 12, a receiver 13 installed independently, four initiators 14 typically installed only in a high-quality vehicle, and a display 15 provided in a cluster or a mirror.

The TPMS sensor 12 is activated and deactivated by an external electronic wave signal, and it outputs a high frequency signal (for example, 345 MHz) regarding the sensor ID and the tire pressure of the tire 11 to the receiver 13.

The receiver 13 receives the high frequency signal from the TPMS sensor, and transmits the signal to the display 15. The receiver 13 is connected to a diagnostic connector.

In a high-quality vehicle, the receiver 13 may output a signal to the initiator 14. The initiator 14 receives the signal from the receiver 13, and outputs an LF signal (for example, 125 KHz) to the TPMS sensor, such that the TPMS sensor outputs the RF signal. The display 15 indicates a pressure fall of the tire 11, and warns the driver of the vehicle 10.

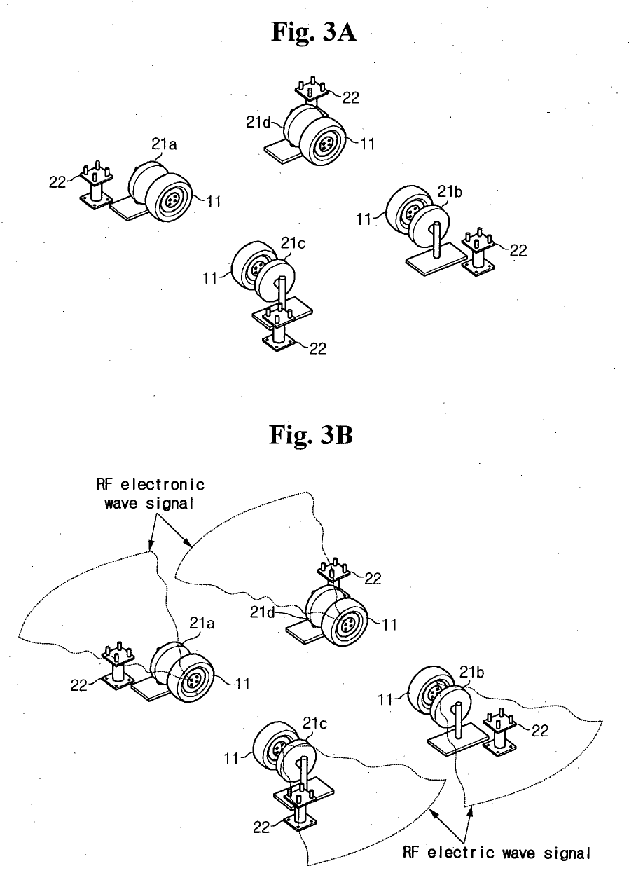

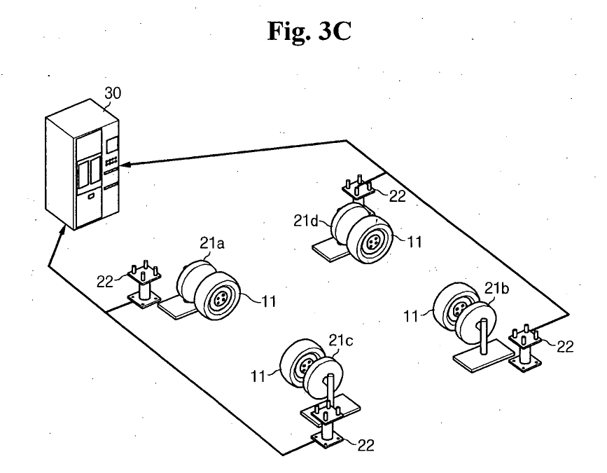

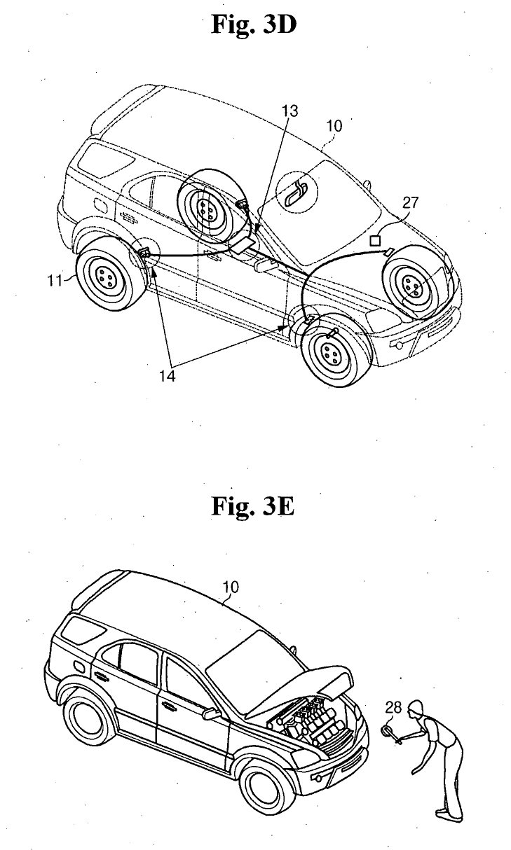

FIG. 3A schematically shows four tires 11 of the vehicle, instead of the entire vehicle, for easier comprehension of the structure of the TPMS. As shown in FIG. 3A, the vehicle is located at the inspection position of the vehicle inspection facility. Then, the four exciters 21a, 21b, 21c, and 21d each generate an LF signal having a frequency of 125 KHz, in order. When the exciters 21a, 21b, 21c, and 21d output the electronic wave signals, the corresponding TPMS sensors 12 (installed at or near the wheel) respond, and output the RF electronic wave signals having a frequency of 315 MHz, as shown in FIG. 3b.

The UHF antennas 22 receive the electronic wave signals from the respective TPMS sensors 12, in order. At this time, each of the electronic wave signals includes information about the ID of the TPMS sensor 12, tire pressure, temperature of the tire, etc.

Subsequently, as shown in FIG. 3C, each of the UHF antennas 22 connected to a TPMS server 30 transmits the signals, including an ID of the UHF antenna 22 and an ID of the TPMS sensor 12, to the TPMS server 30, in order.

Subsequently, the ID mapping of the initiator 14 and the TPMS sensor 12 is confirmed by the ECU of the vehicle and the receiver 13, and all the data of the sensor IDs, pressures, temperatures, etc., are stored in the TPMS server 30.

Then, as shown in FIG. 3E, the operator opens the hood of the vehicle 10 so as to connect a 20 pin connector 27, and inputs the IDs of the TPMS sensors, the tire pressures, etc., to the receiver 13.

If there is a mapping error of the TPMS sensor, the operator retrieves an ID of the TPMS sensor with a hand tool 28, as shown in FIG. 3E. That is, when an error occurs, the operator repairs an error with the hand tool 28.

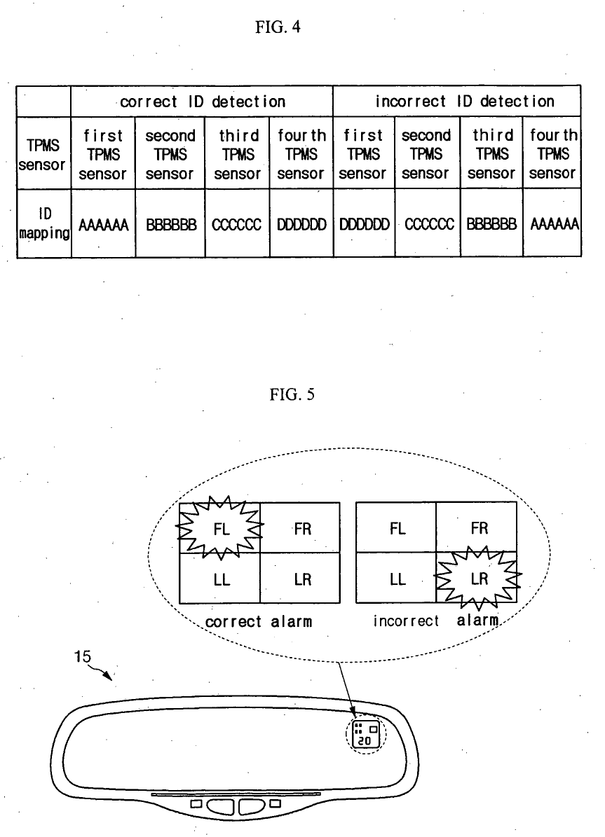

Referring to FIG. 4, a sensor ID of the first TPMS sensor 12a is AAAAAA, a sensor ID of the second TPMS sensor 12b is BBBBBB, a sensor ID of the third TPMS sensor 12c is CCCCCC, and a sensor ID of the fourth TPMS sensor 12d is DDDDDD. At this time, when ID detecting is correctly performed, ID mapping is also correctly performed. However, when ID detecting is incorrectly performed, the ID and the tire are mismatched.

In addition, if the ID mapping is incorrectly performed, an incorrect alarm (due to the sensor ID mapping error) can be indicated through the TPMS display 15 installed in a cluster or a rear view mirror as shown in FIG. 5.

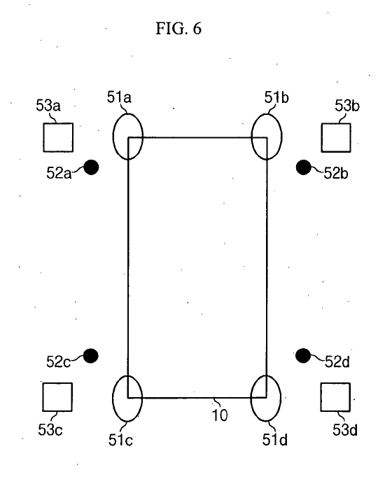

Referring to FIG. 6, a tire pressure monitoring system according to an exemplary preferred embodiment of the present invention includes four TPMS sensors 51a, 51b, 51c, and 51d installed near respective tires of a vehicle 10 for measuring the air pressure of the tires, four exciters 52a, 52b, 52c, and 52d installed separately from the respective tires for activating the respective TPMS sensors, four antennas 53a, 53b, 53c, and 53d separately installed from the respective tires for receiving electronic wave signals from the respective TPMS sensors, and a control portion.

The first antenna 53a, the second antenna 53b, the third antenna 53c, and the fourth antenna 53d are preferably UHF antennas, and may include directional antennas which transmit or receive maximum power in a particular direction.

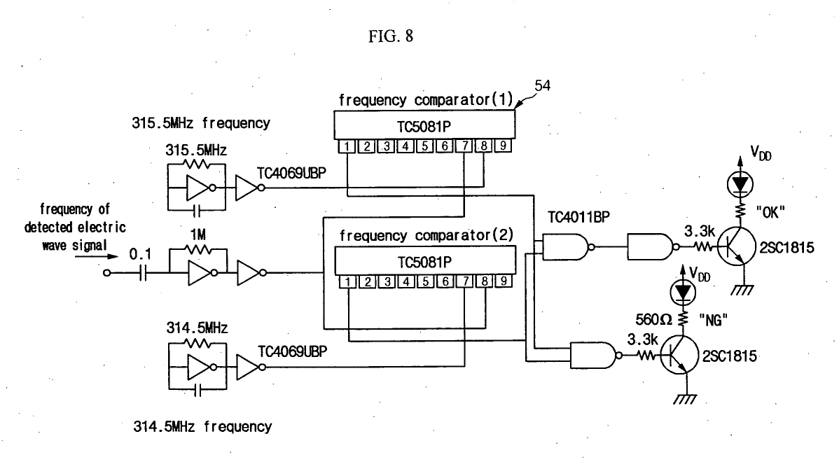

As shown in FIG. 8, a frequency comparator 54 for comparing frequencies of the electronic wave signals is provided in the control portion. The control portion may be installed in the UHF antenna or directional antenna. FIG. 8 is a schematic circuit diagram for determining whether a frequency of a detected electronic wave signal is between 314.5 MHz and 315.5 MHz. The frequency comparator 54 in FIG. 8 will be described later.

Hereinafter, an operation of the tire pressure monitoring system according to an embodiment of the present invention will be described in detail.

Since a typical operation of tire pressure monitoring system is described above, a characteristic operation of an exemplary embodiment of the present invention will be described hereinafter.

After the above-described typical process, four TPMS sensors respectively installed in the four wheels generate and output electronic wave signals including information about tire pressure, temperature, etc., and then the four UHF antennas respectively receive the electronic wave signals from the four TPMS sensors.

In this process, many kinds of signals not relating to the output signal of the TPMS sensor may be inputted to the UHF antenna.

Therefore, all the other electronic wave signals, except the electronic wave signals from the TPMS sensor, must be filtered out, and the frequency comparator 54 is used for this task. As the frequency comparator, an OP-AMP comparator may be used.

Generally, an output electronic wave signal of the TPMS sensor is a 315 MHz LF signal. Therefore, a frequency of the detected electronic wave signal is compared to the predetermined upper limit of 315.5 MHz and predetermined lower limit of 314.5 MHz, and if the frequency of the detected electronic wave signal is included in the frequency range between the upper limit and lower limit, the signal is determined to be a signal from the TPMS sensor.

Hereinafter, the frequency comparison will be described in more detail.

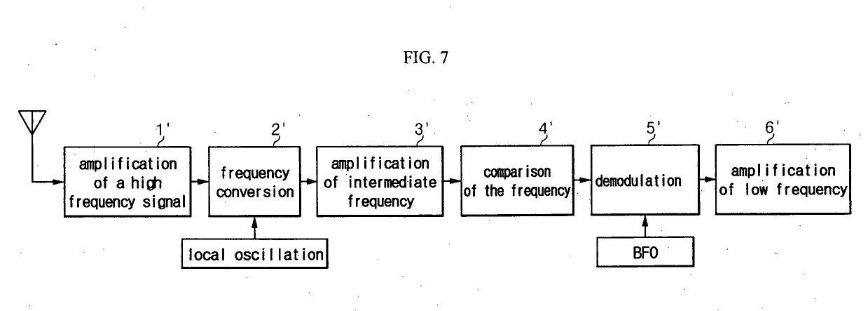

As shown in FIG. 7, an exemplary process in the UHF antenna for receiving the electronic wave signal from a TPMS sensor 51a to 51d according to the present invention may sequentially perform amplification of a high frequency signal 1′, frequency conversion 2′, amplification of an intermediate frequency 3′, comparison of the frequency 4′, demodulation 5′, and amplification of a low frequency 6′. BFO is an abbreviation for beat frequency oscillator.

FIG. 8 shows an example circuit constructed for the purpose of comparing a frequency of the measured electronic wave signal with the predetermined frequency range. However, persons of ordinary skill in the art will appreciate that circuit for comparing frequencies can be structured in a wide variety of other patterns without departing from the scope or sprit of this disclosure.

After comparing the frequency, if the input electronic wave signal of the antenna is determined as a signal from TPMS sensor, then, the wave intensity is determined.

Generally, a wave intensity depends on the existence of obstacles and the distance between the TPMS sensor and the UHF antenna. As the distance or the number of obstacles increased, the wave intensity becomes weaker. Generally, when the electronic wave signal passes through the wheel, the wave intensity decreases approximately 15 dB, and a decrease rate relating to the distance is 2 dB/m.

When values of respective intensities of output electronic wave signal are P1, P2, P3, and P4, each of the intensities can be compared using Equation 1 shown below, in the control portion installed in the UHF antenna.

$${N}_{ab} = 10 {log}_{10} \frac{{P}_{2}}{{P}_{1}} \qquad [ Equation 1 ]$$

Here, Nab is an intensity difference between two electronic wave signals. The control portion selects an electronic wave signal having a maximum intensity, based on 6 values of Nab calculated by comparing wave intensity P1 of a signal from a first TPMS sensor 51a and a wave intensity P2 of a signal from a second TPMS sensor 51b, by comparing wave intensity P1 of a signal from a first TPMS sensor 51a and wave intensity P3 of a signal from a third TPMS sensor 51c, by comparing wave intensity P1 of a signal from a first TPMS sensor 51a and wave intensity P4 of a signal from a fourth TPMS sensor 51d, by comparing wave intensity P2 of a signal from a second TPMS sensor 51b and wave intensity P3 of a signal from a third TPMS sensor 51c, by comparing wave intensity P1 of a signal from a second TPMS sensor 51b and wave intensity P2 of a signal from a fourth TPMS sensor 51d, and by comparing wave intensity P3 of a signal from a third TPMS sensor 51c and wave intensity P4 of a signal from a fourth TPMS sensor 51d. The selected electronic wave signal having maximum intensity is an output electronic wave signal of the TPMS sensor which is desired to be received by a particular antenna. Therefore, based on the Nab, the electronic wave signal including information of the corresponding tire can be acquired.

According to this process, if the LF signal of the first exciter 52a affects the second TPMS sensor 51b, and the second TPMS sensor 51b is activated and outputs the RF signal (315 MHz), a first antenna 53a receives the electronic wave signal from the corresponding TPMS sensor 51b which is the nearest TPMS sensor to the first antenna 53a.

According to an exemplary tire pressure monitoring system of the present invention, a tire pressure monitoring system can prevent the cross-talk phenomenon.

In addition, an error rate due to the characteristics of wireless communication may be decreased, and additional reconfirmation is not required. In addition, the cost of repair and maintenance and the cost caused by customers' complaints can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tire pressure monitoring system, comprising:
a plurality of TPMS sensors for measuring air pressure of respective tires and outputting electronic wave signals corresponding to the pressures;
a plurality of exciters for outputting electronic wave signals for activating the respective TPMS sensors;
a plurality of antennas provided in correspondence to the respective TPMS sensors and receiving electronic wave signals from the TPMS sensors; and
a control portion connected to the antennas and calculating signals received by the antennas,
wherein the control portion compares an intensity of the plurality of electronic wave signals being received by the plurality of antennas,
and selects an electronic wave signal from a particular TPMS sensor among a plurality of electronic wave signals being received by a particular antenna, based on the comparison.

2. The tire pressure monitoring system of claim 1, wherein:
the control portion determines whether a frequency of the electronic wave signal outputted from the TPMS sensor is included in a predetermined frequency range.

3. The tire pressure monitoring system of claim 1, wherein:
the output signal of the exciter is an LF signal having a frequency of about 125 KHz.

4. The tire pressure monitoring system of claim 1, wherein:
the output signal of the TPMS sensor is an RF signal having a frequency of about 315 MHz.

5. The tire pressure monitoring system of claim 1, wherein:
the antenna is a directional UHF antenna, and
the control portion is installed in the antenna.

6. The tire pressure monitoring system of claim 2, wherein:
the control portion includes an OP-AMP comparator for comparing a frequency of the electronic wave signal inputted through the antenna.

7. A method for monitoring tire pressure, comprising:
receiving a plurality of electronic wave signals;
determining whether an electronic wave signal is outputted from a TPMS sensor by comparing frequencies of the electronic wave signal with a predetermined frequency range;
comparing an intensity of the electronic wave signal being received by the antennas, and
selecting a particular electronic wave signal of a specific TPMS sensor corresponding to a corresponding antenna among the plurality of electronic wave signals, based on the comparison.
